(19) United States
(12) Patent Application Publication
(10) Pub. No.: US 2016/0089286 A1
(43) Pub. Date: Mar. 31, 2016

(54) PODIATRY ASSIST

(71) Applicant: Virginia Mason Medical Center, Seattle, WA (US)

(72) Inventors: Matthew Infantino, Seattle, WA (US); Pilar Almy, Seattle, WA (US)

(21) Appl. No.: 14/858,883

(22) Filed: Sep. 18, 2015

Related U.S. Application Data
(60) Provisional application No. 62/055,943, filed on Sep. 26, 2014.

(51) Int. Cl. A61G 5/12

(52) U.S. Cl. CPC A61G 5/12; A61G 2005/127

(57) ABSTRACT

A podiatry assist device for use with a patient in a wheelchair. While the patient remains in the wheelchair, the device supports at least one of the patient's lower extremities as the patient is examined and/or treated. The device includes a pad, a height adjustment mechanism, and a base. At least one of the patient's lower extremities is placed upon and supported by the pad. The height adjustment mechanism is coupled to the pad and operable to raise and lower the pad with respect to the floor. The base is coupled to the height adjustment mechanism and operable to support both the height adjustment mechanism and the pad. Optionally, the device may include a tray.

### CROSS REFERENCE TO RELATED APPLICATION(S)

This application claims the benefit of U.S. Provisional Application No. 62/055,943, filed on Sep. 26, 2014, which is incorporated herein by reference in its entirety.

### BACKGROUND OF THE INVENTION

1. Field of the Invention

The present invention is directed generally to medical devices configured to support one or both of a patients lower extremities during an examination and/or treatment.

2. Description of the Related Art

When visiting a healthcare provider (e.g., a podiatrist), a non-ambulatory patient is unable to transfer from the patient's wheelchairs to an examination chair or table comfortably, safely, and independently. Typically, the healthcare provider must prop up the patient's lower extremity (e.g., leg or foot) in some manner (e.g., using a chair, the other lower extremity, a stack of towels, etc.). While the patient's lower extremity is propped up, the healthcare provider must move uncomfortably around the propped up lower extremity, and discard examination/treatment materials, supplies, and/or other refuse on the floor, which creates an unsanitary environment. If for some reason propping up the patient's lower extremity is unsatisfactory and the patient cannot bear his/her own body weight, the healthcare provider must physically move the patient using a traditional “stand and pivot” body transfer method. This method is physically demanding and may be uncomfortable for the patient and/or the provider. Therefore, a need exists for a device that allows the patient to remain seated in the patient's wheelchair while being examined and/or treated by a healthcare provider. The present application provides this and other advantages as will be apparent from the following detailed description and accompanying figures.

### BRIEF DESCRIPTION OF THE SEVERAL VIEWS OF THE DRAWING(S)

FIG. 1 is an illustration of a podiatry assist device in use in a clinical setting.

FIG. 2 is a perspective view of the device of FIG. 1 with an optional tray.

FIG. 3 is an enlarged perspective view of an upper portion the device of FIG. 1 illustrated with a lower portion of its center frame cutaway.

FIG. 4 is an enlarged perspective view of an embodiment in which a foot pad is attached by a hinge to a height adjustment mechanism.

FIG. 5 is a perspective view of an alternate embodiment of a podiatry assist device.

FIG. 6 is a flow diagram of a method performed by a healthcare provider.

### DETAILED DESCRIPTION OF THE INVENTION

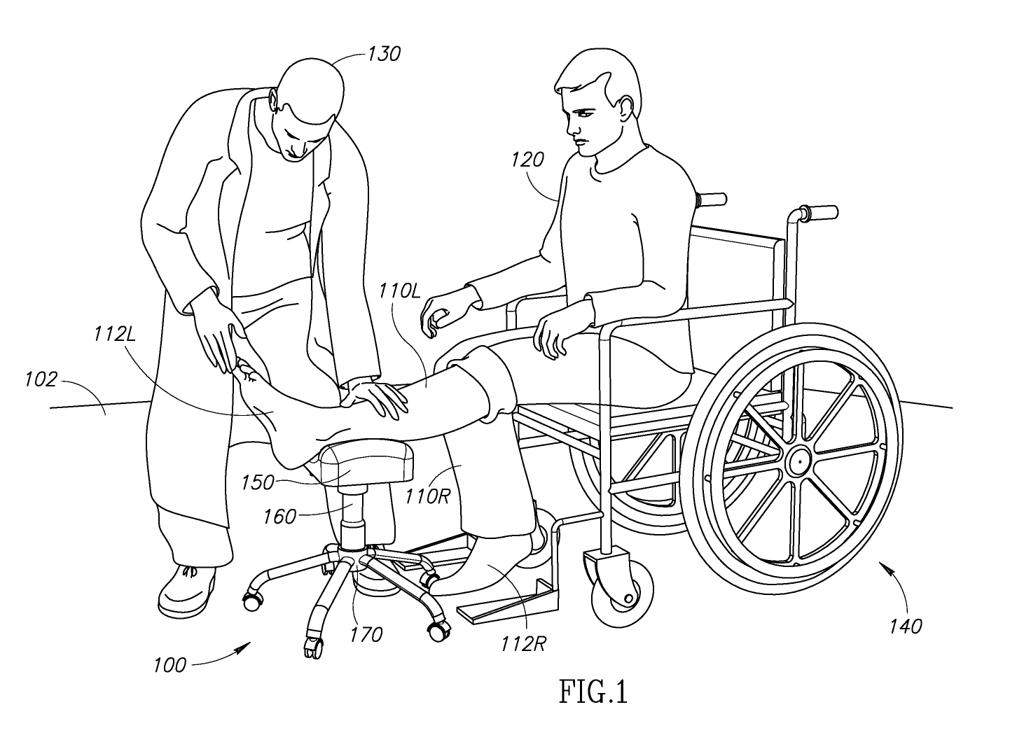

FIG. 1 is an illustration of a podiatry assist device 100 in use with a patient 120 in a clinical setting, such as a hospital, clinic, physician's office, and the like. The device 100 rests upon and is supported by a floor 102. The device 100 is configured to support one or both of the patient's lower extremities during an examination by a healthcare provider 130 (e.g., a physician, nurse, and the like). By way of a non-limiting example, the clinical setting may be a podiatrist's office and the healthcare provider 130 may be a podiatrist.

For ease of illustration, the patient 120 has been illustrated as having both a left leg 110L, a right leg 110R, a left foot 112L, and a right foot 112R. Thus, in this example, the device 100 may be used to support at least one of the patient's legs 110L and 11 OR and/or at least one of patient's feet 112L and 112R. However, as is apparent to those of ordinary skill in the art, the patient 120 may not have two lower extremities and/or may be missing a portion of one or both lower extremities. The device 100 may be used with such patients to provide support to a single lower extremity or a portion of one or both lower extremities.

The device 100 allows the patient 120 to remain in the patient's wheelchair 140 during the examination and any related treatment. Thus, there is no need for the patient 120 to be transferred out of the wheelchair 140 during the examination and/or during any related treatment. The device 100 may be characterized as being an adjustable mobile rest for supporting one or both of the patient's lower extremities (e.g., at least one of the legs 110L and 110R and/or at least one of the feet 112L and 112R).

The device 100 may include one or more features for conducting a full examination of one or both of the patient's lower extremities. Depending upon the implementation details, the device 100 may be configured to support only one of the patient's lower extremities (e.g., one of the legs 110L and 110R and/or one of the feet 112L and 112R) at a time. Alternatively, the device 100 may be configured to support both of the patient's lower extremities (e.g., both of the legs 110L and 110R and/or both of the feet 112L and 112R) at the same time.

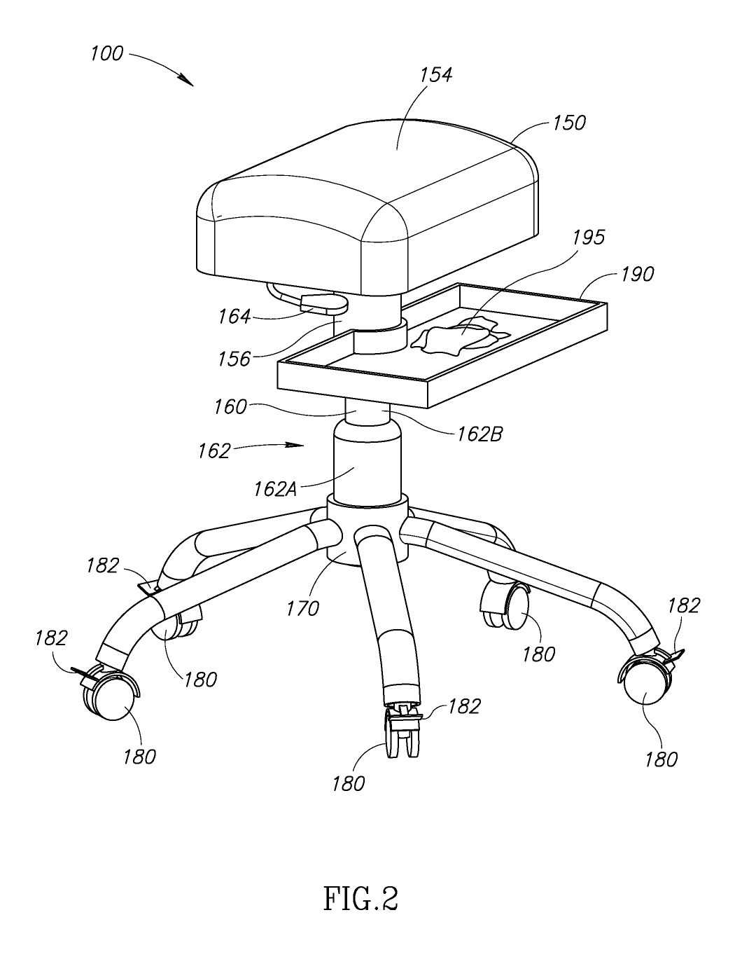

FIG. 2 is a perspective view of the device 100. In the embodiment illustrated, the device 100 includes a cushion or foot pad 150, a height adjustment mechanism 160, and a base 170. The device 100 may be comparable in size to a conventional foot stool. The foot pad 150 is wide enough (e.g., less than about 60 cm) to accommodate both of the patient's lower extremities (e.g., both of the legs 110L and 110R and/or both of the feet 112L and 112R), and thick enough (e.g., approximately 9 cm) to be comfortable to the patient 120.

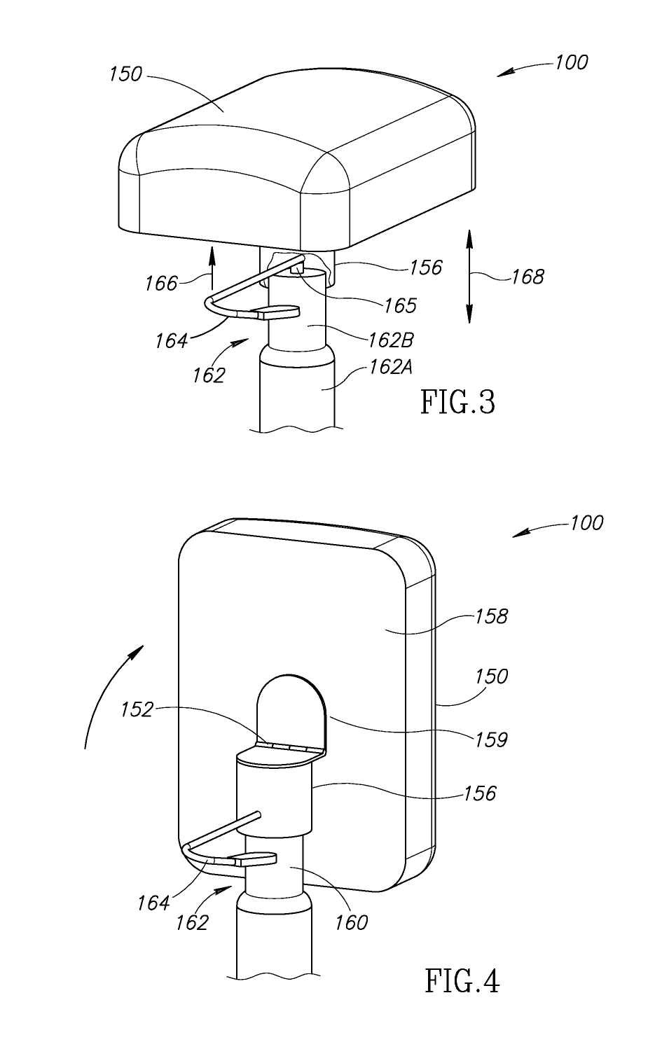

Referring to FIG. 4, the foot pad 150 may be attached to the height adjustment mechanism 160 by an optional hinge 152, pivot mechanism, and the like. In such embodiments, the foot pad 150 may swing or tilt about the hinge 152 from a substantially horizontal position or orientation (shown in FIGS. 1-3) into a substantially vertical position or orientation (shown in FIG. 4) for easy storage. Like reference numerals have been used to identify like components in FIGS. 3 and 4.

Referring to FIG. 2, the foot pad 150 has an upper most surface 154 upon which one or both of the patient's lower extremities (e.g., the legs 110L and 110R or the feet 112L and 112R) may rest. The upper most surface 154 is accessible from all sides along its periphery and from above. Access to the upper most surface 154 is not blocked or impeded by any other structures. In some embodiments, the upper most surface 154 may be contoured (e.g., concave) to help prevent the patient's lower extremity or extremities from slipping off the foot pad 150.

The height adjustment mechanism 160 raises and lowers the foot pad 150 relative to the floor 102 (see FIG. 1). The height adjustment mechanism 160 may be used to position the upper most surface 154 of the foot pad 150 within a height range that extends from a minimum available height (closest to the floor 102 illustrated in FIG. 1) to a maximum available height (farthest from the floor 102 illustrated in FIG. 1). By way of a non-limiting example, the minimum available height may be about 44 centimeters (“cm”) from the floor 102 and the maximum available height may be about 56 cm from the floor 102.

The height adjustment mechanism 160 may be implemented using a conventional gas cylinder 162 operated by a handle or manual lever 164 positioned under the foot pad 150. The gas cylinder 162 may include a stationary housing or outer member 162A and a movable piston or inner member 162B. The inner member 162B is at least partially received inside the outer member 162A and moves linearly (e.g., slides) within the outer member 162A. The foot pad 150 is mounted on the movable inner member 162B and moves therewith.

Referring to FIG. 3, the lever 164 may be lifted manually (e.g., in a direction identified by arrow 166), which presses downwardly on a button 165 coupled to the movable inner member 162B of the gas cylinder 162 allowing the inner member 162B to move linearly (e.g., up or down) with respect to the outer member 162A. When lever 164 is not pressed upon, the movable inner member 162B is locked or prevented from moving linearly (e.g., up or down) with respect to the outer member 162A. As the inner member 162B moves linearly relative to the outer member 162A, the foot pad 150 moves therewith in one of the directions (e.g., up or down) identified by double headed arrow 168.

Referring to FIG. 2, as the inner member 162B moves relative to the outer member 162A, the height of the foot pad 150 relative to the floor 102 (see FIG. 1) changes. For example, when the lever 164 is lifted (to depress the button 165 shown in FIG. 3) and the foot pad 150 is not pressed downwardly, the inner member 162B may be pressed outwardly by compressed gas inside the gas cylinder 162 causing the foot pad 150 to rise relative to the floor 102. On the other hand, when the lever 164 is lifted (to depress the button 165 shown in FIG. 3) and the foot pad 150 is pressed downwardly with sufficient force to overcome the force of the compressed gas on the inner member 1628, the inner member 1628 will move toward (and farther into) the outer member 162A, moving the foot pad 150 closer to the floor 102. When the inner member 1628 moves upwardly, the foot pad 150 is raised. On the other hand, when the inner member 162B moves downwardly, the foot pad 150 is lowered.

In alternate embodiments, pressing on the lever 164 downwardly may cause the inner member 162B to move outwardly from the outer member 162A by a predetermined amount thereby increasing the height of the foot pad 150 by a predetermined amount. In this manner, each time the lever 164 is pressed (or pumped), the foot pad 150 is raised by the predetermined amount. In such embodiments, lifting the lever 164 may cause the inner member 162B to move toward the outer member 162A thereby decreasing the height of the foot pad 150. Alternatively, the height adjustment mechanism 160 may include a manual release (not shown) that when activated, causes the inner member 1628 to move toward the outer member 162A thereby decreasing the height of the foot pad 150 until it reaches the minimum available height.

In the embodiment illustrated, the foot pad 150 is coupled to the inner member 162B and the base 170 is coupled to the outer member 162A. In this configuration, the gas cylinder 162 functions as a support column extending from the base 170 to the foot pad 150. The inner member 162B is coupled to an underside 158 (see FIG. 4) of the pad 150. In the embodiment illustrated, the inner member 162B is coupled at or near a central region 159 (see FIG. 4) of the underside 158 of the pad 150. The foot pad 150 extends laterally outwardly from the gas cylinder 162 in all directions in a cantilever fashion (i.e., without any additional vertical support from another structure). The foot pad 150 is elongated and may have a generally rectangular shape when viewed from above. The foot pad 150 is configured to avoid downward deflection along its periphery when the patient's lower extremity or extremities is/are placed upon the outermost edges of the foot pad 150 (farthest from the support column).

Referring to FIG. 3, the foot pad 150 may be coupled to the inner member 162B by a center frame 156. The lever 164 (underneath the foot pad 150) may be movably attached to the center frame 156 and positioned to be operated by the provider 130 and/or the patient 120.

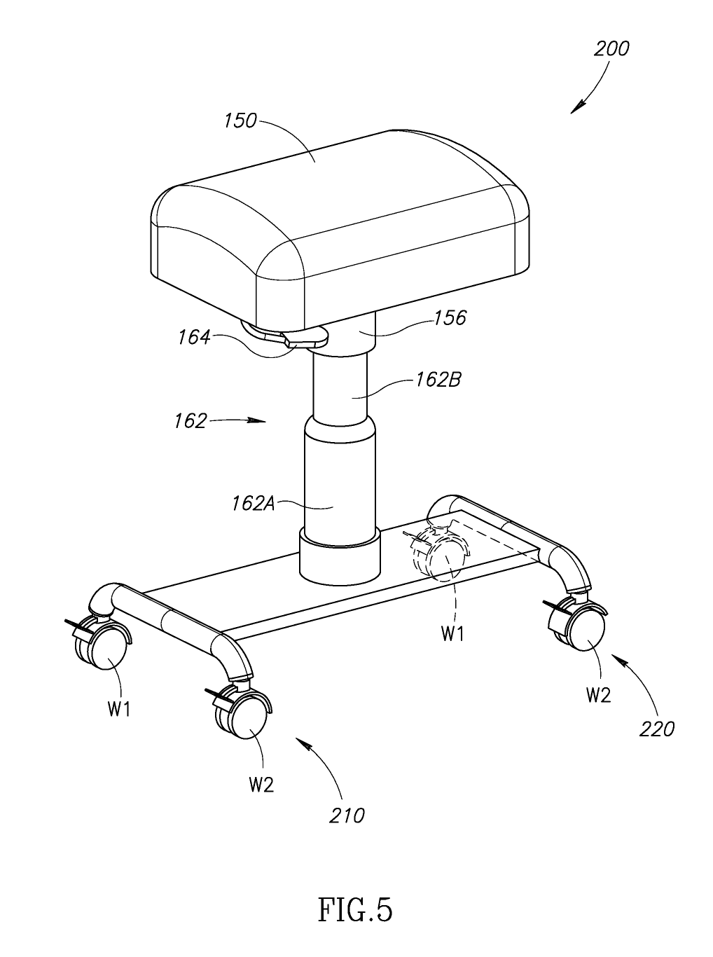

Referring to FIG. 2, the base 170 includes a plurality of casters or wheels 180. The device 100 is configured to be supported by and rolled on the wheels 180 along a floor 102 (see FIG. 1). The wheels 180 each include a wheel lock 182 configured to prevent the wheels 180 from rolling during an examination and/or treatment. In FIGS. 1 and 2, the device 100 includes a single set of five wheels 180. In alternate embodiments, other numbers of wheels (e.g., four, six, etc.) may be used. By way of another non-limiting example illustrated in FIG. 5, a device 200 may include two sets 210 and 220 each including two wheels W1 and W2. Like reference numerals have been used to identify like components in FIGS. 2 and 5.

Referring to FIG. 2, the device 100 may include an optional tray 190 configured to hold materials 195 (e.g., discarded materials, supplies, refuse, etc.) used and/or created during an examination of the patient 120 (see FIG. 1). The tray 190 may be attached to the center frame 156 (see FIG. 3) of the device 100, or to the foot pad 150. The tray 190 may be removable to make discarding its contents (e.g., the materials 195) into the trash easier. By way of a non-limiting example, the tray 190 may have a length that is less than or equal to the length of the foot pad 150.

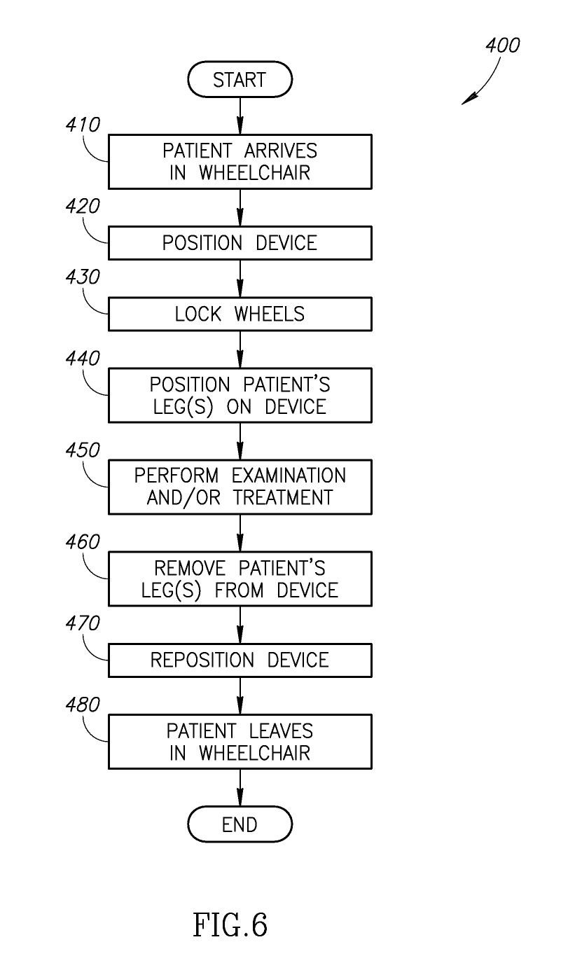

FIG. 6 is a flow diagram of a method 400 of using the device 100 (see FIGS. 1 and 2) or the device 300 (see FIG. 5). For ease of illustration, the method 400 will be described as being performed using the device 100 and with reference to the illustration in FIG. 1. The method 400 may be performed by the provider 130 alone and/or with the assistance of the patient 120. The patient 120 remains in the wheelchair 140 when the method 400 is performed.

In first block 410, the patient 120 arrives in the patient's wheelchair 140 at the clinical setting (e.g., the provider's office) for the patient's appointment, and is positioned at an appropriate location for examination and/or treatment by the provider 130. In block 420, the provider 130 positions the device 100 (e.g., rolls the device 100 on its wheels 180 to a location) near the patient's lower extremity or extremities (e.g., one or both of the legs 110L and 110R) and at an appropriate location for examination by the provider 130. Optionally, the height adjustment mechanism 160 may be used to adjust the height of the foot pad 150. Then, in block 430, the provider 130 locks the wheel locks 182 (see FIG. 2) to prevent the wheels 180 (see FIG. 2) of the device 100 from rolling when the patient's lower extremity or extremities (e.g., one or both of the legs 110L and 110R) are positioned on the foot pad 150.

In block 440, at least one of the patient's lower extremities (e.g., the leg 110L) is positioned on the device 100 (as shown in FIG. 1) by the provider 130 and/or the patient 120. If necessary, the height adjustment mechanism 160 may be used to adjust the height of the foot pad 150 to a height that is comfortable for the patient 120 and/or the provider 130. Optionally, the wheel locks 182 (see FIG. 2) may be unlocked and the device 100 repositioned. Then, the wheel locks 182 (see FIG. 2) are locked again to prevent the device 100 from rolling during the examination and/or treatment.

In block 450, the examination and/or treatment is performed. By way of a non-limiting example, the patient's lower extremity or extremities positioned on the device 100 in block 440 (or a portion of portions of the lower extremity or extremities) may be examined and/or treated in block 450. Alternatively, other anatomical structures may be examined in block 450.

In block 460, the patient's lower extremity or extremities that were positioned on the device 100 in block 440 are removed from the device 100. Then, in block 470, the device 100 may be moved to a location where the device 100 will not interfere with the patient 120 leaving and/or the provider's duties. Finally, in block 480, the patient 120 may leave the provider's office in the wheelchair 140. Then, the method 400 terminates. Thus, as mentioned above, the patient 120 remains in the wheelchair 140 and does not need to leave the wheelchair 140 to be examined and/or treated.

Referring to FIG. 1, the device 100 and the device 300 (see FIG. 5) both provide alternatives to removing the patient 120 from the wheelchair 140. This avoids the need for the traditional “stand and pivot” body transfer for patients who cannot bear their own body weight. It also decreases the duration of the appointment. The devices 100 and 300 may be used by providers (e.g., podiatrists) practicing in clinical settings and are not exclusive to any organization, region, or demographic. The devices 100 and 300 may be used by providers in general orthopedics with patients who need full lower leg examinations and cannot be transferred safely from their wheelchairs to an examination table. This population includes patients in post-operative states, as well as patients that are frail, have severe pain, and/or are sick.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A device for use with a patient having a lower extremity, the device comprising:
a pad configured to support the patient's lower extremity;
a height adjustment mechanism coupled to the pad, the height adjustment mechanism being operable to raise and lower the pad; and
a base coupled to the height adjustment mechanism, the base being operable to support the height adjustment mechanism and the pad.

2. The device of claim 1, wherein the height adjustment mechanism comprises a single support column that extends between the height adjustment mechanism and the pad.

3. The device of claim 1, wherein the height adjustment mechanism is a hydraulic cylinder comprising a movable inner member received partially inside an outer member,
the inner member is slidable with respect to the outer member,
the outer member is coupled to the base,
the inner member is coupled to the pad, and
the pad moves with the inner member when the inner member is slid with respect to the outer member.

4. The device of claim 3, wherein the height adjustment mechanism further comprises a manually operated lever that when operated allows the inner member to slide with respect to the outer member.

5. The device of claim 1, further comprising:
a tray removably coupled to the pad for movement therewith.

6. The device of claim 5, further comprising:
a central frame that couples the pad to the height adjustment mechanism, the tray being removably coupled to the central frame.

7. The device of claim 1, wherein the base comprises a plurality of wheels each having a corresponding wheel lock operable by a user to selectively prevent the wheel corresponding to the wheel lock from rolling.

8. The device of claim 1, wherein the pad has an upper surface accessible from all sides along its periphery and from above.

9. The device of claim 1, wherein the pad has a contoured upper surface configured to help maintain the patient's lower extremity thereupon.

10. The device of claim 1 for use with the patient's lower extremity being a first lower extremity and the patient also having a second lower extremity, wherein the pad is configured to support both the patient's first and second lower extremities at the same time.

11. The device of claim 1, wherein the height adjustment mechanism comprises a single support column that extends between the height adjustment mechanism and the pad,
the pad is pivotably coupled to the single support column, and
the pad may be pivoted with respect to the single support column between a first substantially horizontal position and a second substantially vertical position.

12. The device of claim 1, wherein the pad is pivotably coupled to the height adjustment mechanism, and
the pad may be pivoted with respect to height adjustment mechanism between a first substantially horizontal position and a second substantially vertical position.

13. A method for use with a patient in a wheelchair, the patient having at least one lower extremity, the method comprising:
positioning the wheelchair with the patient therein at a desired location;
positioning a mobile support device at a selected position near the patient while the patient remains in the wheelchair, the mobile support device comprising a plurality of selectively lockable wheels and a height adjustment mechanism operable to determine a height of a pad;
locking the plurality of wheels of the mobile support device to prevent the wheels from rolling;
operating the height adjustment mechanism to adjust the height of the pad of the mobile support device;
positioning the at least one lower extremity of the patient on the pad of the mobile support device while the plurality of wheels are locked and the patient remains in the wheelchair;
at least one of examining and treating the patient while the at least one lower extremity of the patient is positioned on the pad of the mobile support device and the patient remains in the wheelchair; and
after the at least one of examining and treating the patient, removing the at least one lower extremity of the patient from the pad of the mobile support device while the plurality of wheels are locked and the patient remains in the wheelchair.

14. The method of claim 13, further comprising:
placing materials in a tray coupled to the mobile support device.

15. The method of claim 14, further comprising:
removing the tray from the mobile support device; and
discarding the materials placed in the tray.

16. The method of claim 13, wherein the at least one of examining and treating the patient is a full lower leg examination, and the patient cannot be transferred safely from the wheelchair to an examination table.

17. The method of claim 13, wherein the patient cannot bear the patient's own body weight.

18. The method of claim 13, wherein the patient is in a post-operative state or the patient is at least one of frail, experiencing severe pain, and sick.

19. A device for use with a patient having a lower extremity, the device comprising:
an elongated pad having an underside with a central region, the pad being configured to support the patient's lower extremity;
a hydraulic cylinder coupled to the central region of the underside of the pad, the hydraulic cylinder providing vertical support to the pad, the elongated pad extending outwardly from the hydraulic cylinder without any additional vertical support from another structure, the hydraulic cylinder being operable to raise and lower the pad; and
a base configured to support the hydraulic cylinder.

20. The device of claim 19, further comprising:
a tray removably coupled to the underside of the pad.
